(19) United States
(12) Patent Application Publication
(10) Pub. No.: US 2008/0235128 A1
(43) Pub. Date: Sep. 25, 2008

(54) SYSTEMS, METHODS, AND COMPUTER PROGRAM PRODUCTS FOR INTEGRATING EXECUTION PLATFORMS WITH ORDER MANAGEMENT SYSTEMS

(75) Inventors: James R. TWINE, Boston, MA (US); Ricardo X. RABINES, Boston, MA (US); Eric SUGDEN, New York, NY (US); Cynde CARLEY, Hingham, MA (US)

Correspondence Address: ROTHWELL, FIGG, ERNST & MANBECK, P.C., 1425 K STREET, N.W., SUITE 800, WASHINGTON, DC, 20005, US

(73) Assignee: ITG SOFTWARE SOLUTIONS, INC., Culver City, CA (US)

(21) Appl. No.: 12/052,481

(22) Filed: Mar. 20, 2008

Related U.S. Application Data
(60) Provisional application No. 60/918,910, filed on Mar. 20, 2007.

(51) Int. Cl. G06Q 40/00

(52) U.S. Cl. 705/37

(57) ABSTRACT

Systems, methods, and computer program products are provided for integrating an order management system with execution facilities. According to the invention, at least one trade in an order management system (OMS) is selected to be or otherwise made available to be worked in an execution platform (EP). Order information in the OMS, corresponding to the at least one trade, is sent from the OMS to the EP without committing the underlying shares for the trade. It is determined if the EP is attempting to generate, or has generated, an executable trade order corresponding to the order information received from the OMS. If the determining step is positive, the shares corresponding to the executable order are committed in the OMS

### CROSS-REFERENCE TO RELATED APPLICATIONS

Pursuant to 35 U.S.C. § 119(e), this application claims the benefit of priority to U.S. Provisional Patent Application No. 60/918,910, which was filed on Mar. 20, 2007, the entire contents of which are incorporated herein by reference.

### BACKGROUND OF THE INVENTION

1. Field of the Invention

The present invention relates generally to systems and methods for integrating order management systems with execution platforms in trading networks. In particular, the present invention relates to systems and methods for tightly integrating an order management system with one or more execution platforms to allow for advanced order and placement management.

2. Description of the Related Art

Historically, in the financial trading industry, traders have managed their work by writing down their planned and active trades in a ledger, called a “blotter.” Recently, with the advancement of computer technology, “blotters”, once limited to paper, have evolved into computerized systems called Order Management Systems (OMSs). One such OMS is the MACGREGOR XIP product offered by ITG INC. (See, e.g., www.itg.com).

During the same time period that “blotters” were evolving into OMSs, trading forums—matching destinations for the trades—which had typically consisted of manned trade desks, were also evolving into electronic order matching systems. One such matching or “crossing” system is POSIT, and is owned and operated by ITG INC. However, OMSs did not originally include functionality for submitting electronic orders to electronic trade venues, such as POSIT. Instead, a separate platform evolved specifically for the purpose of generating electronic trade orders. These platforms are called execution platforms (EPs) or execution management systems (EMSs).

Currently, a trader typically utilizes an OMS to manage the information relating to their portfolios, while at the same time utilizing a separate EP to generate trades. In order to ensure the proper execution of trades, the trader is compelled to manually update information in both systems. If traders do not manually update their OMSs and subsequently the information sent to EPs, they expose themselves to trade mismanagement, such as over-execution of a trade position.

Recently, OMSs have been integrated with EMSs such that portfolio or trade information can be shared between the systems electronically with or without manual intervention. However, such integrations have not been robust.

Accordingly, there remains a need for effective, safe, and robust integration of trader OMSs and EPs. The execution platform integration systems and method of the present invention can fill this need.

### SUMMARY OF THE INVENTION

Further applications and advantages of various embodiments of the present invention are discussed below with reference to the drawing figures.

According to embodiments of the present invention, systems and methods are provided for integrating an order management system (OMS) with one or more execution management systems (EMS), also known as execution platforms (EP).

According to embodiments of the present invention, the integration can be configured to allow trades to be available in an EP to be worked without committed the trades (e.g., creating a placement) in the OMS. The placement is created in the OMS “just-in-time,” when an executable trade order is generated, or attempted to be generated, at the one or more EPs.

According to embodiments of the present invention, systems and methods are provided for integrating an order management system with execution facilities by selecting at least one trade in an OMS to be available to be worked in an EP; sending order information corresponding to the at least one trade from the OMS to the EP without committing shares underlying the at least one trade; determining if the EP is attempting to generate or has generated an executable order corresponding to the order information received from the OMS; and if said EP is determined to have generated or attempted to generate an executable order corresponding to the at least one trade in the OMS, creating a placement corresponding to executable order at the OMS.

According to embodiments of the present invention, a trade integration system for an OMS is made up of OMS data storage facilities for storing trade data, an OMS user interface coupled with the OMS data storage facilities and configured to create and maintain said trade data, and order generation facilities coupled with at least the data storage facilities and configured to generate, in response to an instruction of the OMS user interface, one or more orders to trade securities and transmit the orders to a user selected destination, and to update the trade data to reflect the generated and transmitted orders. Further, the trade integration system is made up of execution platform integration facilities coupled with at least said data storage facilities and an execution platform (EP), and configured to synchronize data in said EP and the data storage facilities but without committing shares in the OMS to the EP until an executable order is generated by the EP.

The system and methods of the present invention can further include means for controlling the level of integration between the OMS and EP—ranging from a basic update of information on the two systems to a full subscription implementation via a middleware component. A full subscription implementation may be effected using publish and subscribe technology.

### BRIEF DESCRIPTION OF THE DRAWINGS

FIG. 1 is a block diagram of a trading system according to an embodiment of the present invention.

FIG. 2 is a block diagram of an exemplary system integrating a trader OMS with an EP according to an embodiment of the present invention.

FIG. 3 is a flow diagram of an exemplary method of creating a pessimistic placement in a trading environment according to an embodiment of the present invention.

FIG. 4 is a flow diagram of an exemplary method of creating an optimistic placement in a trading environment according to an embodiment of the present invention.

FIG. 5 is a sequence diagram illustrating data flow according to an embodiment of the present invention.

FIGS. 6a-6x are screen shots of an OMS blotter integrated with an EP system via a FIX protocol connection.

FIGS. 7a-7r are screen shots of an OMS blotter integrated with an EP system via an execution platform integration system according to embodiments of the present invention.

### DETAILED DESCRIPTION OF THE PREFERRED EMBODIMENTS

While the present invention may be embodied in many different forms, a number of illustrative embodiments are described herein, with the understanding that the present disclosure is to be considered as providing examples of the principles of the invention, and such examples are not intended to limit the invention to any specific preferred embodiments described and/or illustrated herein.

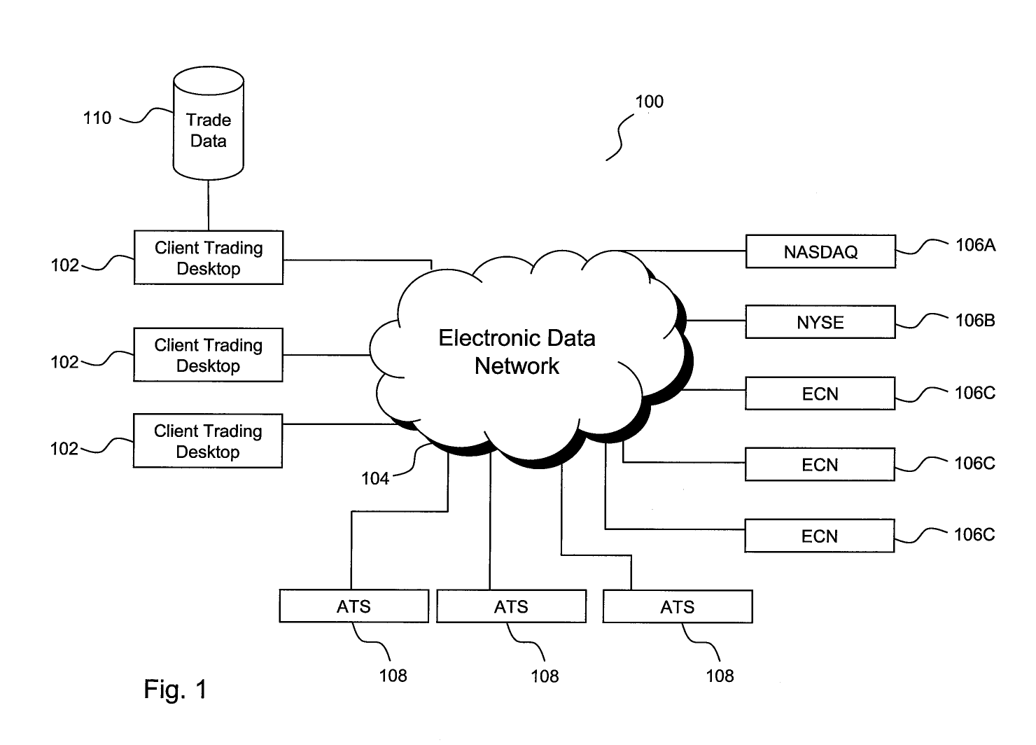

FIG. 1 is a block diagram illustrating salient features of a trading network 100 that includes a trading platform of an order management system (OMS) fully integrated with one or more execution platforms (EPs) according to an embodiment of the present invention. The trading network 100 may include one or more client trading desktops 102 that may be electronically coupled with an electronic data network 104. Also coupled with the electronic data network 104 are a plurality of trading forums including, but not limited to, displayed destinations such as the NASDAQ 106A, NYSE 106B, and ECNs 106C, and non-displayed destinations, such as a plurality of Alternative Trading Systems (ATSs) 108. ITG INC., the assignee of the present invention, owns and operates several ATSs including POSIT, POSIT Match, and POSIT Now.

As described in further detail below, each client trading desktop 102 may include an OMS coupled with one or more EPs, which may or may not be associated with a broker, for creating, updating, canceling, transmitting, and tracking trade lists, portfolios and/or orders, and may be configured to transmit trade orders directly to the destinations via the electronic data network 104 using a FIX connection or the like. Commercially available OMSs and EPs are known. For example, ITG INC., the assignee of the present invention, offers several EMS and OMS solutions (see, www.itg.com). As another example, MACGREGOR XIP, an OMS, has been integrated with a third-party EP, called REDI Plus (REDI+), which is offered by GOLDMAN SACHS EXECUTION & CLEARING, L.P. (see, e.g., www.redi.com). Several of the screen shots described below refer to XIP and REDI Plus; however, the present invention is not limited to any combination of OMS with an EP.

According to embodiments of the present invention, integration can be facilitated by an execution platform integration program (EPIP) or application programming interface (API). The EPIP acts as an active, event driven integration layer for an OMS that allows third party EPs to integrate and utilize OMS features, data, etc. The EPIP may accomplish the sharing of data between an OMS and one or more EPs through the use of a subscription mechanism, such as a publish and subscribe messaging system. The system may utilize middleware, as necessary, to correspond protocols or the like between the OMS and EPs.

The subscription mechanism may be configured to allow selective third-party access to real-time market and analytics information in the OMS. This integration allows third-party EPs to react in real-time to trade information found in a trader's OMS with the underlying shares being initially committed or “placed” with the broker. One type of real-time triggering event is the creation, reallocation, and/or execution of electronic orders, such as FIX order generation. Further, the present invention may allow a trader to utilize event triggered algorithms in response to actions at a third-party EP.

When combined, the features of the present invention provide a tight integration with the safety of a high-level of isolation, i.e., minimal trade data leakage, between the OMS system and the third-party EPs.

In addition to EPs, the EPIP can also be used for integration of OMSs and third-party research and analytics providers.

According the embodiments of the present invention, integration can be made in a variety of manners including, but not limited to subscription, scrape, and FIX-based order creation. However, push-style, event driven communication is preferred.

Subscription integration can utilize both an exposed API (e.g., EPIP) and a callback mechanism that pushes ticket-level information and events. In contrast, scrape-style integration utilizes just the exposed API and requests ticket-level information via a pull mechanism. FIX-based order creation integration utilizes electronic orders that are created via a special message received via FIX. Each of these types of integration may be used separately or in conjunction with each other.

The present invention enhances the manner with which placements and orders have been traditionally created and maintained. The trade data of the present invention is synched in an OMS and EP simultaneously. The present invention is different from the traditional “staged model”, and instead, utilizes a new Just-In-Time (JIT) model.

JIT placement means that placement in the OMS are not created until live orders are generated at an EP. This allows the underlying shares in the OMS to remain “workable”, while at the same time being evaluated for execution by one or more EPs. This is in contrast to existing systems that instead, treat the underlying shares as committed so as that they cannot be worked in multiple systems concurrently. By allowing orders to remain workable in the OMS, the present invention has the advantage that traders may increase the chances for favorable execution of their trade lists.

JIT Placements can be created in at least two ways, “optimistic” and “pessimistic”. In an Optimistic Placement, the EP first creates the placement (i.e., the live order) and then notifies the trader OMS of the EP placement. This manner of placement strategy is termed optimistic because the trader is hopeful that nothing will prevent the successful creation of the corresponding placement on trader's OMS. That is, the order is sent before first committing the shares at the OMS. However, because in the present invention, the OMS and EP are integrated in real-time, very little risk is associated with Optimistic Placement.

In Pessimistic Placement, the EP notifies the trader's OMS that it is about to create an order before actually creating it. This allows the trader OMS to confirm that the corresponding OMS placement is created, and optionally to perform any compliance validation necessary. Further, this prevents the EP order from being placed if anything prevents the creation of the corresponding OMS placement, such as a Compliance (COMPAlert) violation.

The present invention also provides for, but is not limited to, the integration of the EPIP in to the system using COM technology, the FIX protocol, and an infrastructure that allows for synchronization of two complex systems.

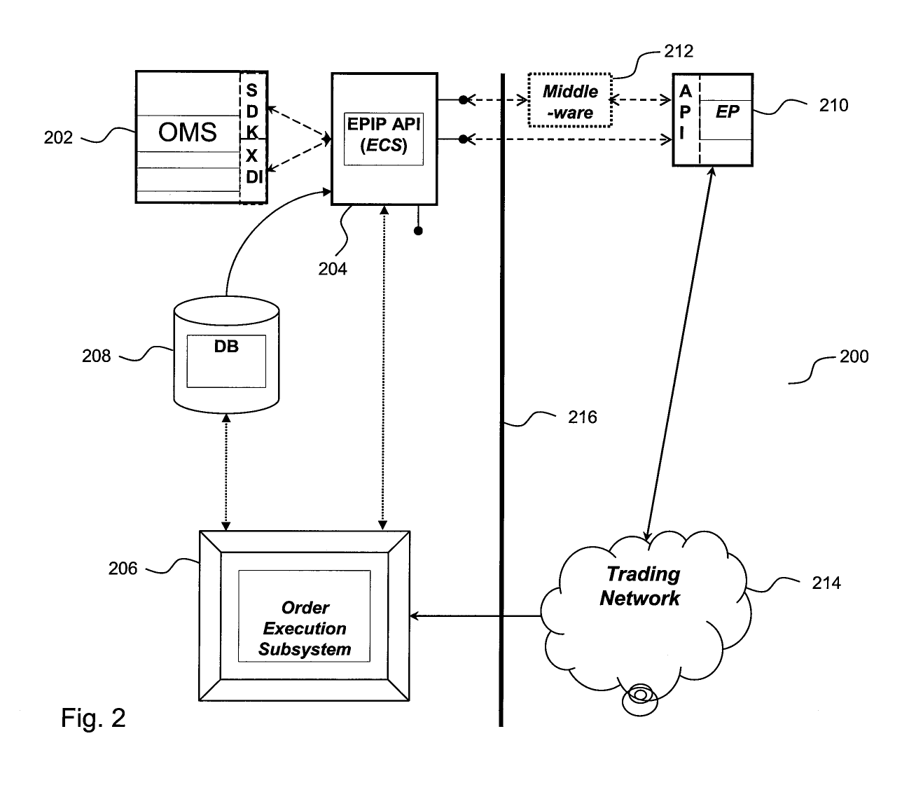

FIG. 2 is a block diagram of an exemplary trading platform 200 according to an embodiment of the present invention, which includes an OMS 202 that is integrated with one or more EPs 210 through the use of an interface, an EPIP 204. System 200 may include the OMS 202 coupled with an EPIP 204, an order execution subsystem, such as the FIX based MACGREGOR Electronic Trading Engine (MET) 206, and a database or data storage facilities 208. One or more third-party EPs 210 are electronically coupled with at least the EPIP 204.

Line 216 merely illustrates which components (202, 204, 206, 208) are typically proprietary to the trader, and the components (210, 212, 214) that are external to the trader and would typically be proprietary to a third-party, usually a broker.

The OMS 202 may be configured to support most of the needs of a trading firm, and may include facilities for powerful portfolio management, compliance (ITG Compliance), trading, and post-trade applications (ITG Trade Ops) with a fully integrated and supported financial services IP network (ITG NetSM). MACGREGOR XIP, an OMS owned and operated by ITG INC., enables buy-side firms to execute their investment decisions with increased speed, control, and efficiency, which results in improved performance.

Further, the use of an OMS 202 allows a trader to:

(1) easily evaluate the impact “what-if” trades have on your portfolio with integrated, real-time market data and up-to-date portfolio information;

(2) rebalance portfolios and generate all necessary orders in seconds;

(3) save time appraising portfolio positions with fast, intuitive and multi-dimensional decision support tools;

(4) help prevent costly compliance violations with pre-trade checks of regulatory, company, and client-specific compliance guidelines;

(5) eliminate time-consuming ticket preparation;

(6) improve client support with the ability to provide real-time status updates

(7) satisfy best execution requirements with “plug-and-play” connectivity to all major global brokers, ECNs and exchanges through ITG NetSM;

(8) enjoy advanced integration with market leading execution platforms, pre-trade analytics solutions, and major algorithmic trading providers;

(9) lessen market impact by instantly linking real-time liquidity information to open orders;

(10) trade with confidence by knowing up-to-the-minute cash positions and knowing your trade has already been checked for compliance; and

(11) increase productivity and reduce errors by eliminating intra-day manual processes and end-of-day batch processing

The OMS 202 includes facilities for a trader “blotter”, and includes a user interface that can execute on the client trading desktop 102. The OMS 202 may use a variety of different communication protocols that allow external applications to interface with it, such as SDK or XDI. The OMS 202 is in communication with the EPIP 204.

The EPIP 204 is in communication with the OMS 202, preferably via an API. This type of connection allows the trader to take actions in the OMS 202 that trigger the functionality of the EPIP 204. For example, a menu item entitled “Send Order To EP” could be added to the OMS 202, and when this menu item is activated the EPIP's 204 functionality could be activated.

The EPIP 204 may include a COM interface implemented within a COM Server, i.e. the EPIP server, which may be executed on the client trading desktop 102 in the “background.” This interface may provide the functionality of the EPIP 204, and is in communication with, either directly or via middleware (discussed below), at least one third-party EP 210. In some embodiments of the present invention, two COM interfaces are used, the primary interface and a callback interface. These COM interfaces are used to inform the EP 210 of triggering events and changes made to the information in the OMS 202.

The EPIP 204 is in communication with both the OMS 202 and the EP 210. Additionally, the EPIP 204 could also maintain a read-only communication link with database 208. The database 208 may be provided locally on the client trading desktop 102 or remotely, in a separate data storage facilities or server 110.

A database link between EPIP 204 and database 208 can be provided such that the EPIP 204 can track the status of orders as they are executed or “worked” by the OMS 202, and subsequently update the order information as necessary. The EPIP 204 can track the status/changes of orders in the OMS 202 using a periodic updating mechanism, such as a timer based update, or preferably, subscribes to receive real-time messages from the database.

When changes have occurred in the OMS 202 that need to be communicated to the EP 210, the EPIP 204 notifies the EP 210 of changes via the callback interface. The updating feature of the present invention is facilitated, in some embodiments of the present invention, by the EPIP server having access to the corresponding OMS login credentials, i.e., username and password. These credentials may be stored, for example in an INI type file, and be encrypted to protect against misuse.

In some embodiments of the present invention, the EPIP 204 is responsible for all interactions between the OMS 202, the EP 210, and the order execution subsystem 206, (further discussed below).

In some embodiments of the present invention, the COM object will be implemented inside of a COM service. This prevents the need for changes to be made to the existing OMS code. The COM service may run as an application (not as a Win32 service), similar in manner to a MICROSOFT OFFICE application. This application will normally be hidden from the trader. It will not normally show a visible interface except for an SNA icon that can be used to provide configuration, notification, and troubleshooting functionality.

The order execution subsystem 206 is coupled and in communication with the EPIP 204. The order execution subsystem 206 can be configured to handle processing of FIX messages, such as FIX order generation, handling of incoming execution or fill messages, and effecting corresponding updates to the OMS database 208.

In some embodiments of the present invention, the order execution subsystem 206 has functionality including, but not limited to, broker neutral functionality, the suppression of outgoing FIX messages, and automatic acknowledgement of these suppressed FIX messages.

The broker neutral functionality of the present invention, allows executions to be matched according to the value in the FIX Exec Broker field, to their broker assignments. Generally, this process makes use of only the broker code associated with the FIX connection. However, the increased functionality of the present invention allows executions for different brokers to be communicated over the same FIX connection.

The capability to suppress outgoing FIX messages supports the JIT placement methods described above. For example, when creating placements from the OMS 202 based on an EP 210 order, the system needs to suppress the outgoing FIX message because the corresponding order was generated by the EP 210. Likewise, because the system is not sending out a message, the system will not receive an acknowledgement. Thus the system must generate acknowledgments automatically for these newly created placements so that they are able to handle the incoming executions. This functionality works for New Orders, as well as Cancels and Modifies (Cancel/Replace).

In some embodiments of the present invention, the Subsystem 206 has the ability to match executions to placements via the FIX message field OrderID. The reason for this new functionality is discussed in further detail below.

The EP 210 may be connected to the trader side of system 200 via the EPIP 204, as discussed above. Additionally, the EP 210 may be connected to the trading network 214 associated with the corresponding broker. One function of the EP 210 is to create orders in the trading network 214, which can be based on trader information found in the OMS 202 that was shared with the EP 210. When orders are made by the EP 210, the order information is updated in the trader side of system 200. As described above, the update can be made by JIT placement.

OMS 202 and EP 210 updates can be effected by known methods. For example, as described above, an existing order execution subsystem 206 can be utilized to create a placement while simultaneously suppressing an associate outbound FIX message.

In some embodiments of the present invention, the middleware component 212 is used to facilitate communication between the EPIP 204 and the EP 210 if conflicting or incompatible data or message protocols exist. For example, if an EP 210 lacked the capability to create and transmit the specific callback required by the EPIP 204, but instead is able to handle externally generated events using a proprietary protocol, the middleware component 212 would be used to implement the necessary callback interface and pass along events to the EP 210 via its event system. In other embodiments, the middleware component 212 may be used to remedy the situation where the EP 210 and the EPIP 204 are incompatible. Use of the middleware component 212 is not necessary in all embodiments of the present invention.

One skilled in the art will recognize that the OMS 202 should be configured to handle “fill” data coming from the trading network 214. In one embodiment, the order execution subsystem 206 is electronically connected to the trader side of system 200. The EP 210 is capable of creating placements in the trading network 214, and in the event that these placements are executed against, the executions are received at the order execution subsystem 206. In some embodiments of the current invention the trading network 214 will facilitate the transmission of FIX messages.

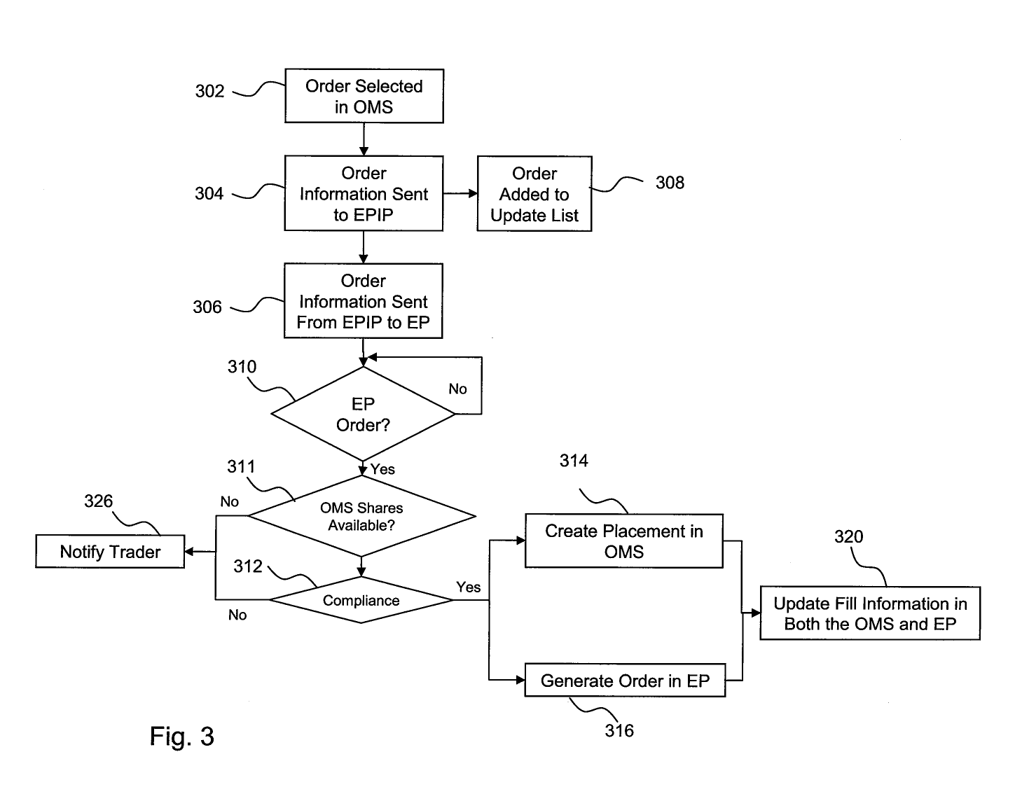

FIG. 3 is a flow diagram of an exemplary method of creating a pessimistic placement in the trading environment of the current invention. At step 302, OMS order information is selected by the OMS user to be transmitted to an EP. At step 304, information about the flagged order(s) in the OMS is communicated to the EPIP. Once the order information is at the EPIP, two steps are taken.

First, at step 308 the EPIP records the order identification information for the order(s) flagged for execution. Also, at step 306 the order information is communicated or sent from the EPIP to the EP. This is done so that the EPIP can watch for changes made to the order (steps 310, 320). This communication may either be direct, or may be facilitated by a middleware component, as discussed above.

At step 310, the system checks to see if the EP is generating an order corresponding to an order in the EPIP list. If yes, at step 311a check is performed to make sure the shares are available to be committed at the OMS. For example, as described above, a placement may be created in the OMS by the order execution subsystem. The potential placement is checked for compliance at step 312. If either of steps 310 or 312 have negative results, the traders are notified by the system, at step 326. These notifications can be in the form of pop-up windows, text alerts, or the like.

If the potential placement information satisfies the compliance information two steps are simultaneously taken. At step 314, the placement corresponding to the EP order is made in the OMS, thereby committing the shares thereto and, at step 316, the EP creates the corresponding order. The two corresponding placement and order are corresponded by an order id, such as CLOrderID in FIX.

When the order is executed, the fill data is updated in both the OMS and the EP at step 320.

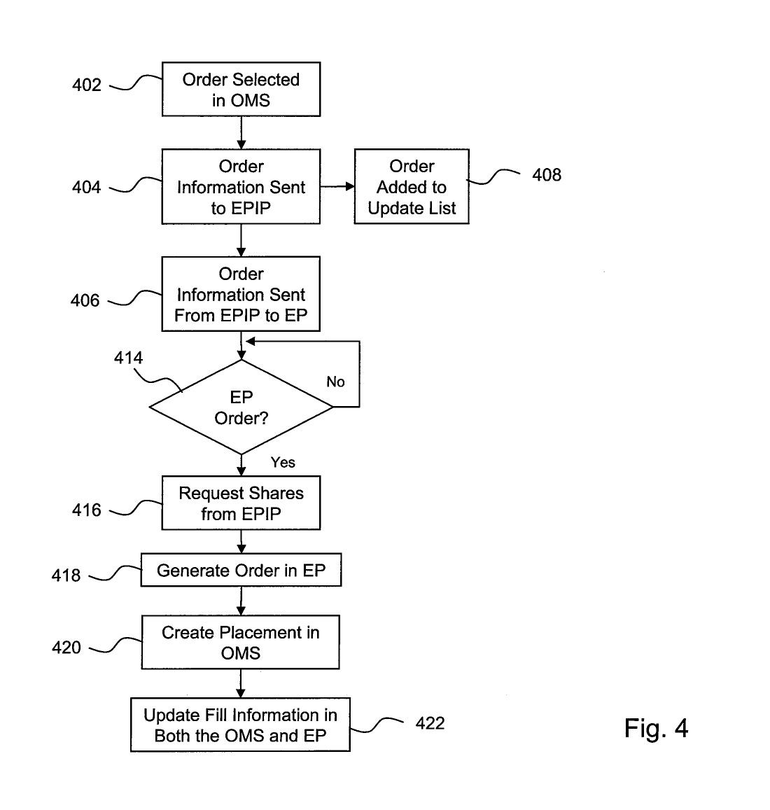

FIG. 4 is a flow diagram of an exemplary method of creating an optimistic placement in the trading environment according to an embodiment of the present invention.

At step 402, an order is selected by the trader in the OMS. This order is flagged for execution by the trader in the system. Alternatively, the system may have an automatic execution system that executes trades based on predefined logic, also called auto-trading. This logic can either be user-defined or system default values. At step 404, information about the flagged order(s) in the OMS is communicated to the EPIP. Once the order information is at the EPIP, two steps are taken.

First, at step 408 the EPIP records the order identification information for the order(s) flagged for execution. This is done so that the EPIP can watch for changes made to the order(s). If changes have occurred, the order information is updated and sent to the EP. Also, at step 406, the order information is communicated, or sent, from the EPIP to the EP. This communication may be direct or may be facilitated by a middleware component, as discussed above.

At step 414, the EP is watched to determine whether the shares are worked by the broker. At step 416 the EP requests the shares that are to be placed from the EP. At the time that the shares are to be worked, the EP creates the order for execution at step 418. Next, at step 420, the OMS placement is created using the OrderID for the order from the EP. At step 422, when the order is executed, fill data is received and used to update both the OMS and the EP.

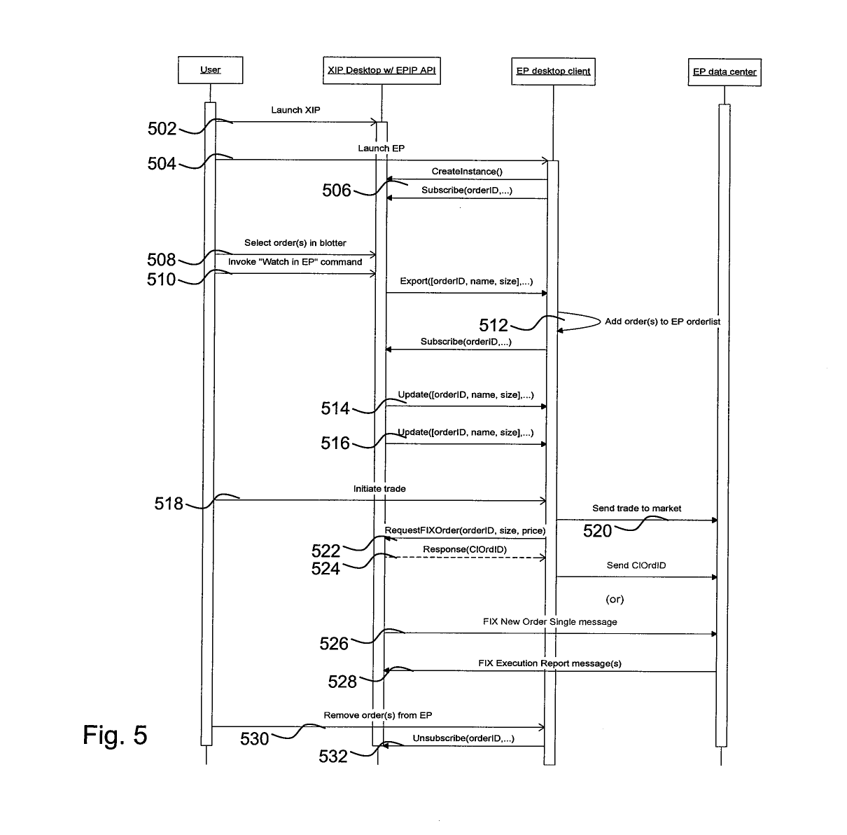

FIG. 5 illustrates an exemplary data flow for two-way event-driven communication between an OMS and one or more EPs, according to embodiment of the present invention.

First, at step 502, the user launches the OMS, such as by launching an executable OMS application module from a client desktop. Next at step 504, the user will also launch one or more EP applications in a similar fashion. The launch registers the EP desktop client with the EPIP API. As described above, the OMS may include features for launching EP applications from the OMS client user interface.

At step 506, the EP desktop client communicates with the OMS to create an instance therein, and to subscribe to certain information in the OMS. One skilled in the art will readily understand that messaging protocols can be utilized to transfer information according to the present invention. For example, a message may be sent to the EPIP API from the EP desktop client.

At step 508, the user may select orders in the OMS's blotter to be transmitted to a selected EP application. This action can invoke commands so that the orders at the EP are “watched” by the EPIP API. In step 510, the OMS exports or transmits order information to the EP desktop via the EPIP API and begins “watching” the EP for updates to the order information.

As described above, when order information is transmitted to the EP, a list is maintained by the EPIP API of the relevant order information. Accordingly, the orders are added to the EP trade order list in the OMS EPIP API at step 512. In some embodiments of the present invention, although the order data is transmitted to the EP, the shares themselves are not committed to the broker associated therewith, and therefore, as it relates to the OMS, the transmission of order information from the OMS to the EP is not yet a “placement.” Accordingly, the order data in the OMS database is not updated at this point, and the OMS user is free to work the underlying as he or she sees fit.

At steps 514 and 516, updates are “pushed” from the OMS to the EP. There, updates can be triggered by events, such as the generation of an live order at the OMS or the EP. The updates are changes made to the order information stored in the EP application or the OMS database. As described above, the data is not merely polled or swept, but is instead event driven and “pushed.”

At step 518, the user may initiate a trade (i.e., a “live” order) via the EP application desktop, which in turn sends the order to a selected market or trade forum at step 520. However, since the shares have not technically been “placed” with the EP, the EPIP receives a message from the EP indicating that an order is to be sent and that a placement is required, at step 522. At step 524, the EPIP API responds to the request, and the order ID is forwarded from the OMS to the EP data center, thereby placing the order with the broker. It is not until this point that the shares are removed from the OMS database, i.e., that the OMS considers the shares to be a placement with the broker associated with the EP.

At steps 526-528, in an alternative embodiment, FIX orders may be sent directly from the OMS through the EP desktop to the EP data center with a FIX execution report (i.e., fill data) being sent directly back to the OMS.

At step 530, if the user decides to remove orders from the EP that were originated from the OMS, the EP desktop unsubscribes to the EPIP API at step 532.

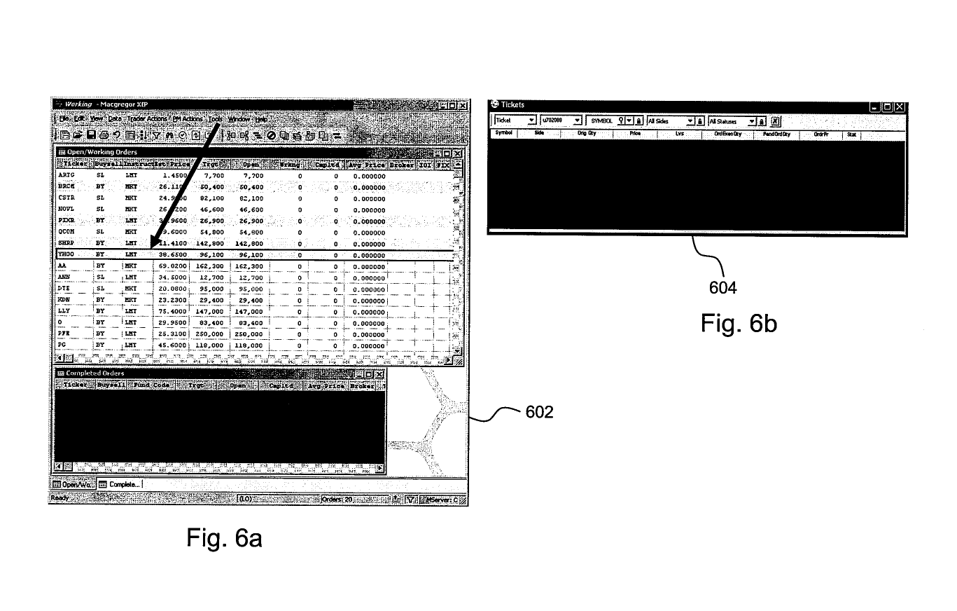

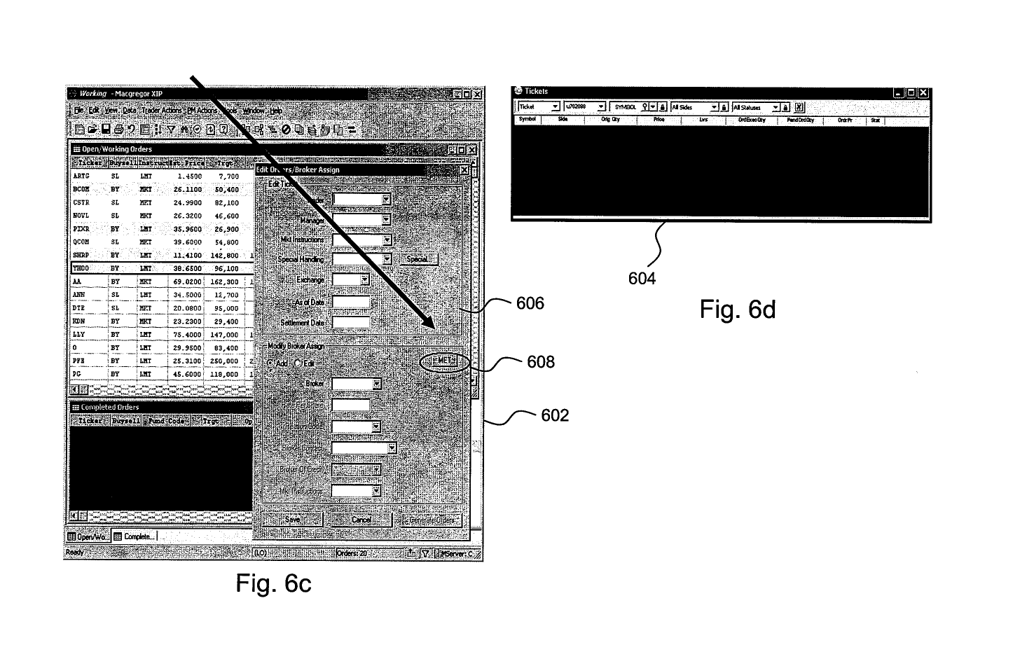

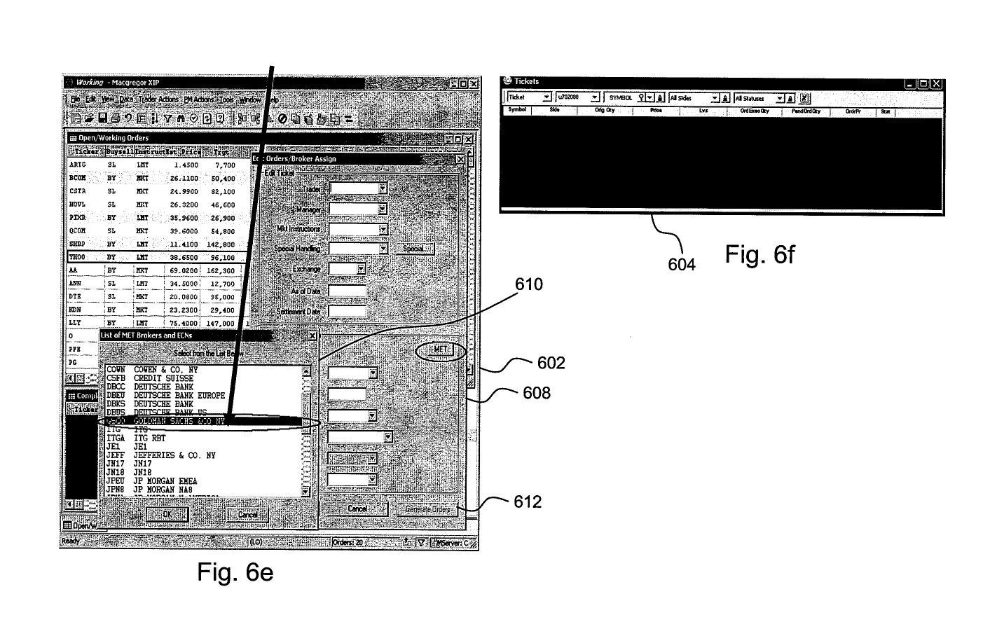

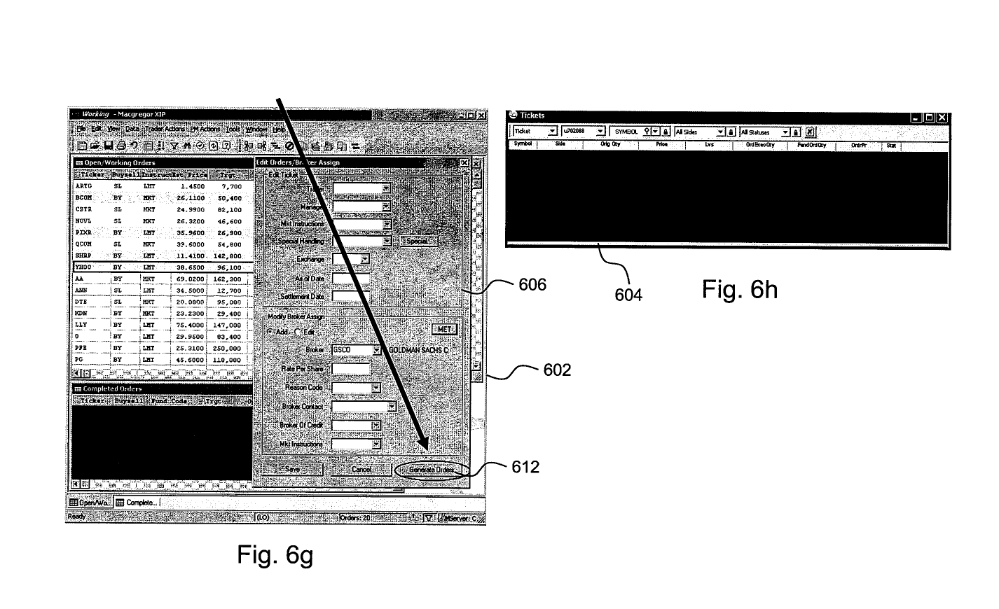

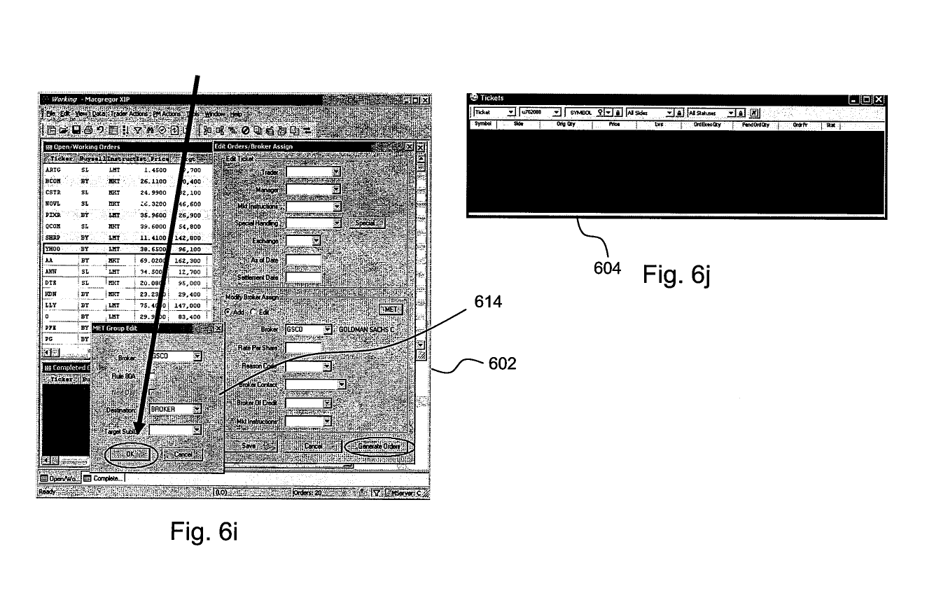

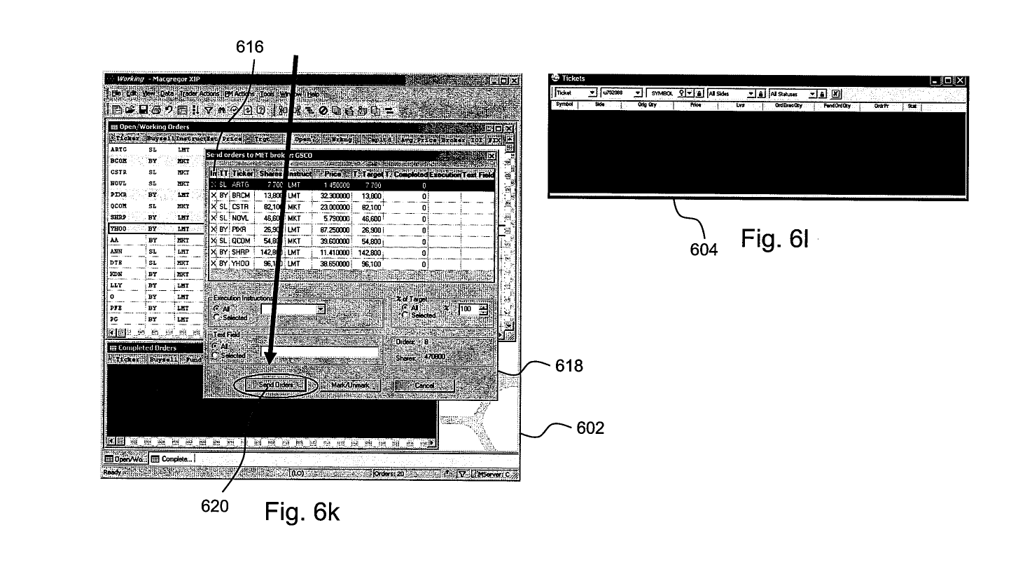

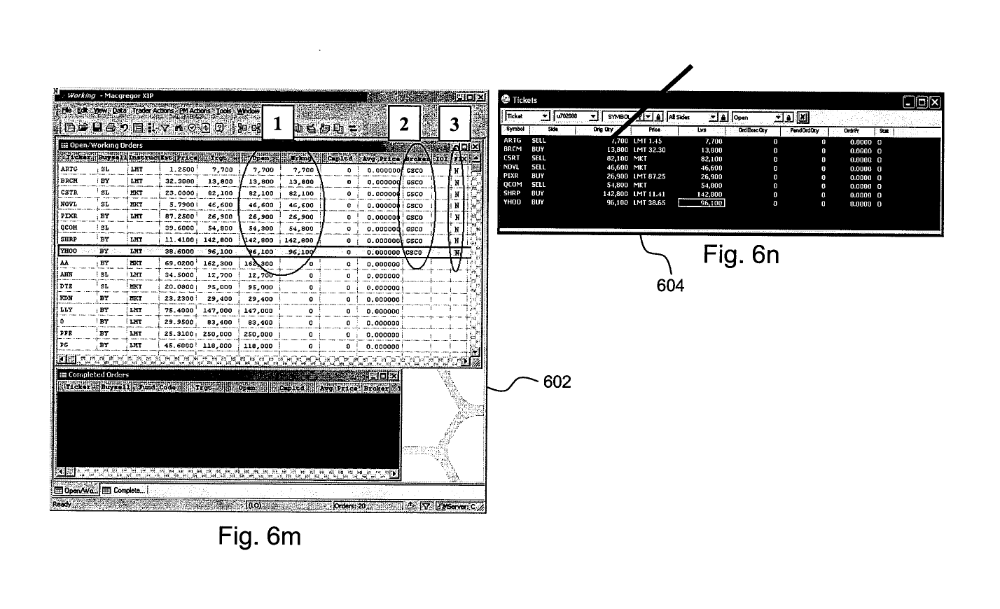

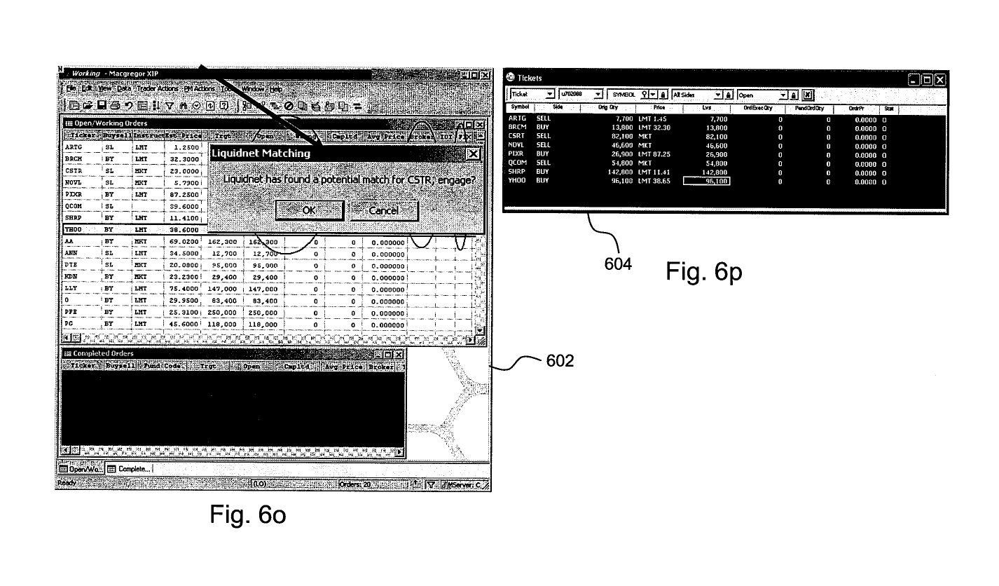

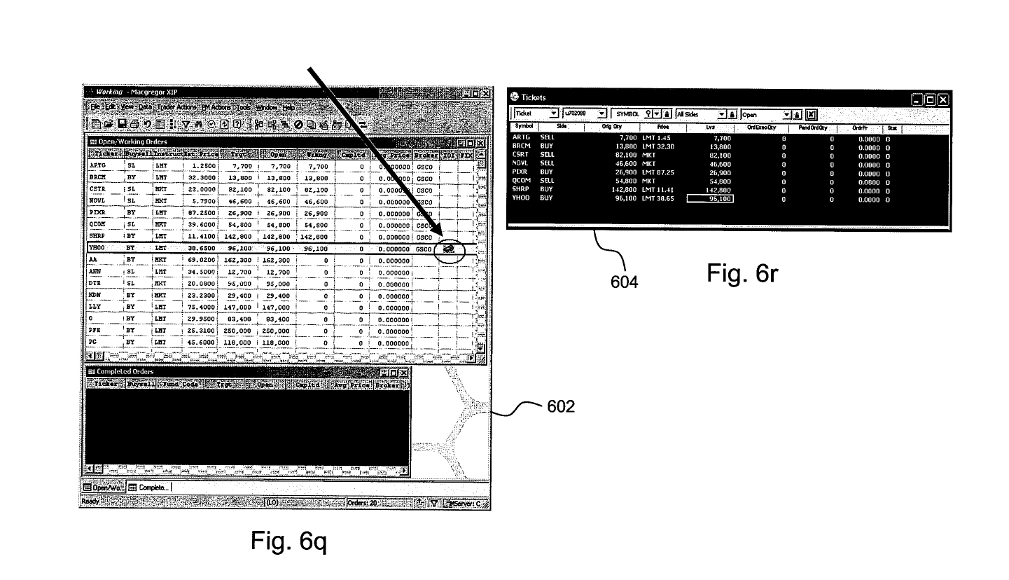

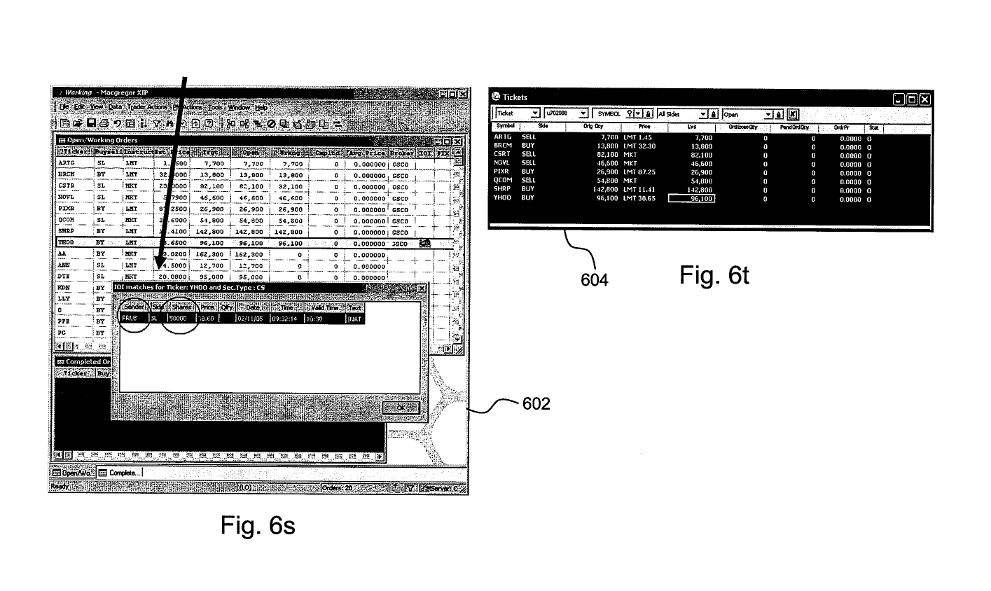

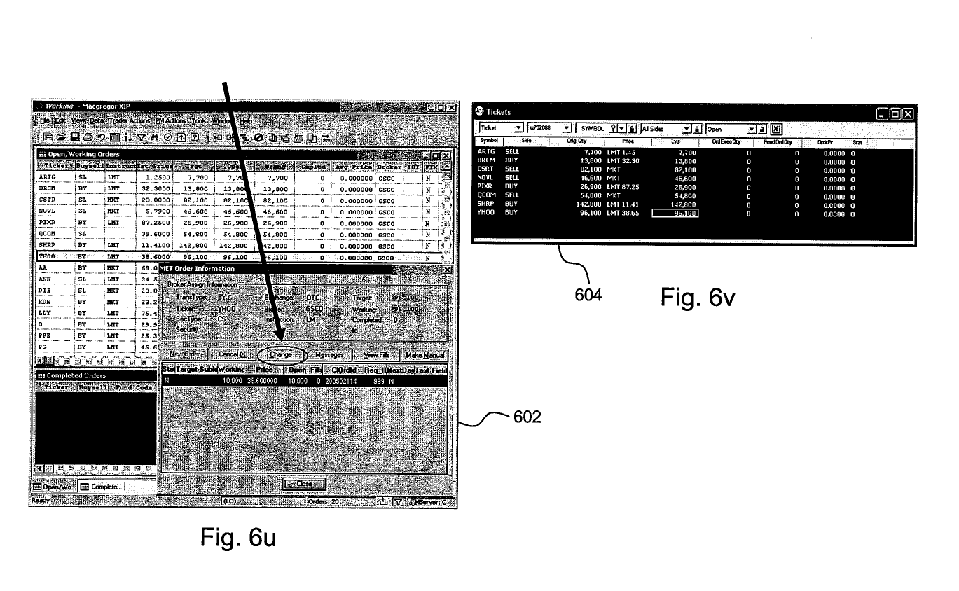

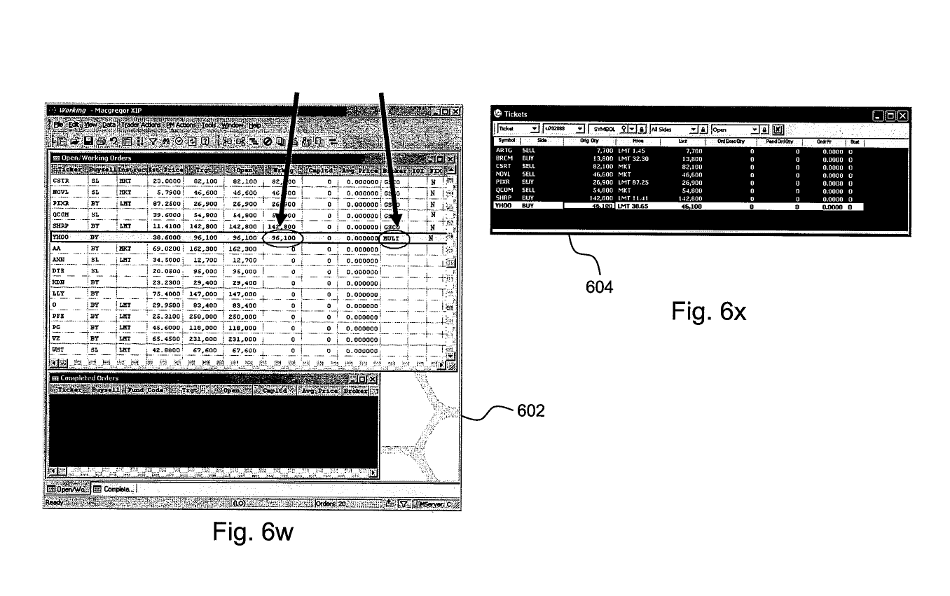

FIGS. 6a-6x include screen shots of an OMS application blotter screen 602 and an EP application ticket blotter screen 604 at various steps during a placement of shares from the OMS to the EP for trading in the EP.

As illustrated in FIGS. 6a and 6b, the user may select trades to be sent from the OMS to the EP by, for example, mouse clicking on the records in the OMS blotter 602. An exemplary OMS blotter may include fields for the ticker sign, the side of a trade (sl=SELL, by—BUY), the type of order (e.g., limit, market, etc.), the estimated price, which may be based on real-time ticker information, target number of shares to be traded, the number of shares that have not been priced with a broker yet (“open”), the number of shares that are working, the number of shares that have been executed, the average price of the execution, the broker to which the shares have been assigned if a placement to a broker is made, whether an indication of interest (IOI) has been received from an IOI system, and whether a fix order has been issued corresponding to the entry of order information. In typical arrangements, an OMS includes an OMS database that stores the trade data that sits behind (i.e., the data displayed in) the OMS user interface 602 (see, e.g., FIG. 2).

As shown at FIG. 6b, an exemplary EP ticket blotter 604 may include the symbol, side, the original quantity, price, the amount of shares left (Lvs), order execution quantity, the pending order execution quantity, the order price, and the status of many orders.

FIG. 6c shows a popup at 606, which is a means for selecting a broker EP for which to assign orders. A button at 608 is provided for accessing the FIX engine for sending FIX orders to the EP ticket blotter 604.

As shown in FIG. 6e, a list box 610 can provide for selecting a broker associated with the EP ticket blotter 604. Note that the generate orders button 612 is not highlighted until this selection has been made. Also note that at FIG. 6f, the orders have yet been sent to the EP ticket blotter 604.

In FIG. 6g, it is shown that the broker has been selected Goldman Sachs (EP=REDI) within the popup 606 and the generate orders button 612 is now highlighted. As shown in FIG. 6i, selection of the generate orders button may optionally provide a confirmation popup 614, which provides the user the last opportunity to cancel or change the selection of broker. Upon selection of the confirmation in the popup, another window can be provided that stages the orders to be transferred to the EP ticket blotter 604. The window 618 may include a column 616 with a check box for selecting which trade orders to be transmitted. Further, other fields may be updatable. A send orders button 620 can be provided which, when activated, will execute the FIX engine facilities within the OMS to transmit the orders by fix to the EP ticket window 604.

As illustrated in FIGS. 6m and 6n, the selected group of orders is transmitted from the OMS to the EP ticket blotter 604 and various fields have been updated in the OMS blotter 602 to reflect these orders as being committed (i.e., placed) with the broker (e.g., Goldman Sachs) associated with the EP (e.g., REDI). Since these orders are placed to a broker EP system, they are not available in the OMS, and therefore cannot be worked by the user in the OMS. For example, as illustrated in FIGS. 6o and 6p, indications systems, such as Liquidnet, could provide a popup as a potential match for communication based on something in the order management system blotter. However, in this case, the security CSTR is committed to Goldman Sachs, and is listed in the EP ticket window 604. Therefore, this popup would not happen because the shares are committed to Goldman Sachs.

Also, as illustrated in FIGS. 6q and 6r, the OMS may have functionality for identifying when an IOI exists for a particular security. However, since the shares have been committed to Goldman Sachs, in order to act on this IOI, the trader must first cancel orders from Goldman Sachs and then choose the liquidity that has been returned to the OMS system. This is illustrated in FIGS. 6s-6v.

As shown in 6s, an IOI match exists. Therefore, as shown in 6u, the user will have to use the OMS facilities to change the FIX order from the OMS to the EP to cancel the order to Goldman Sachs. Only at such time as the liquidity has been regained in the OMS from the EP, can shares of Yahoo be allocated to the source of the IOI, as shown in FIG. 6w.

Accordingly, the order management system utilizing a FIX engine to allocate shares to the EP suffers from the disadvantage that liquidity is not readily accessible.

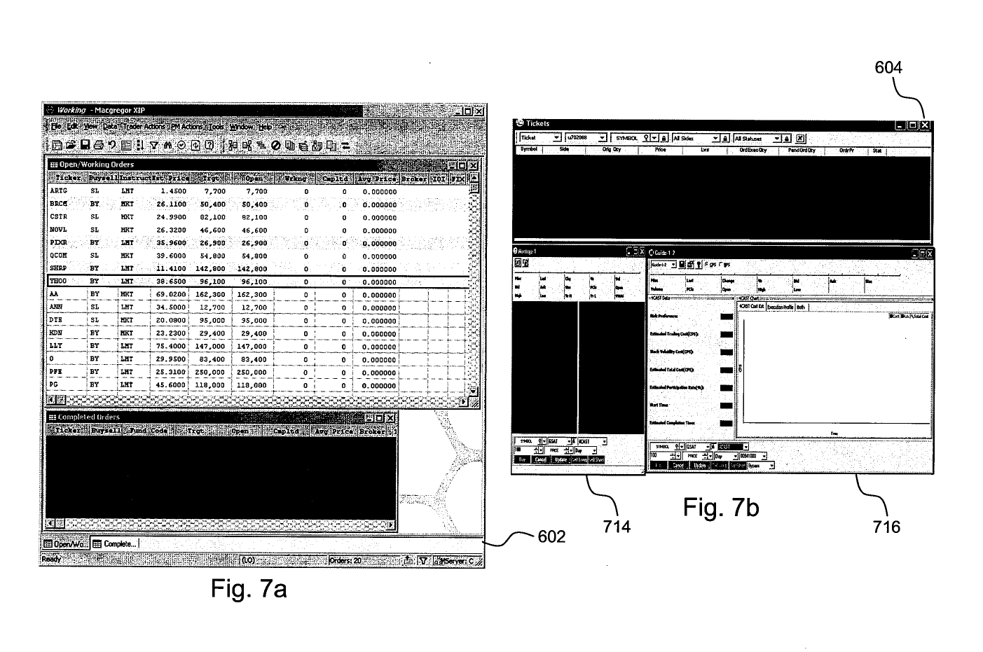

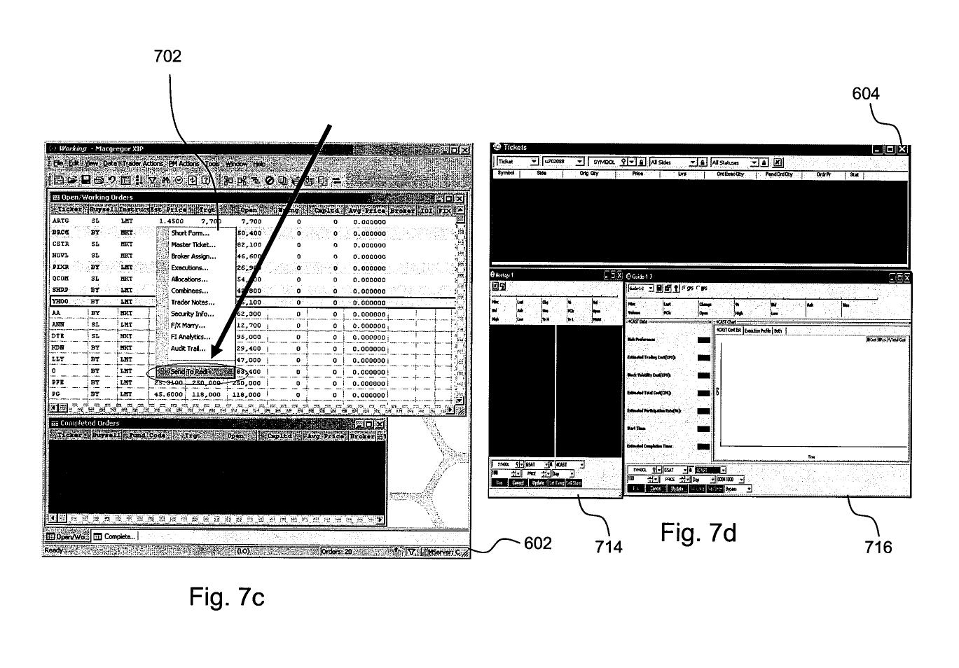

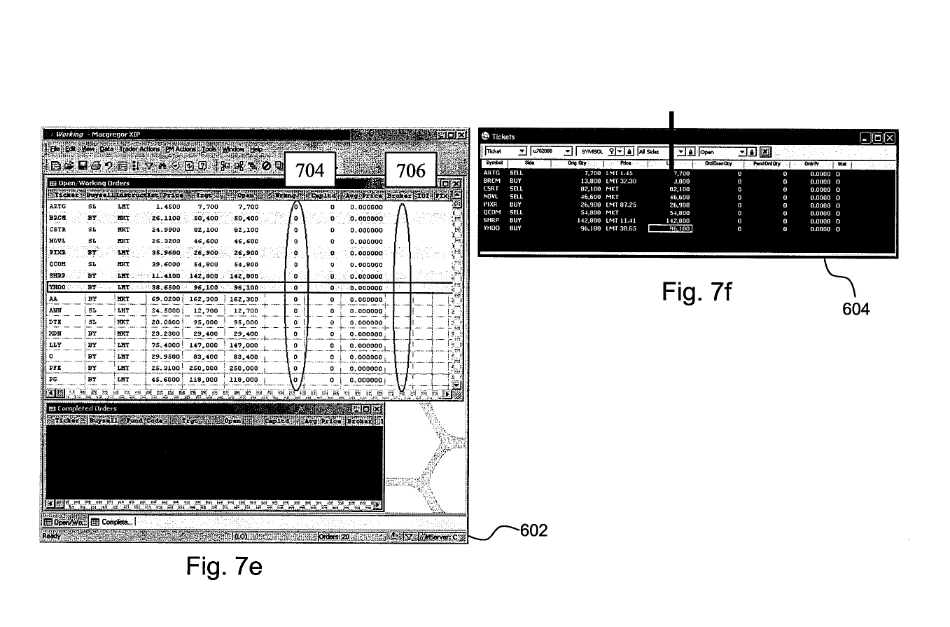

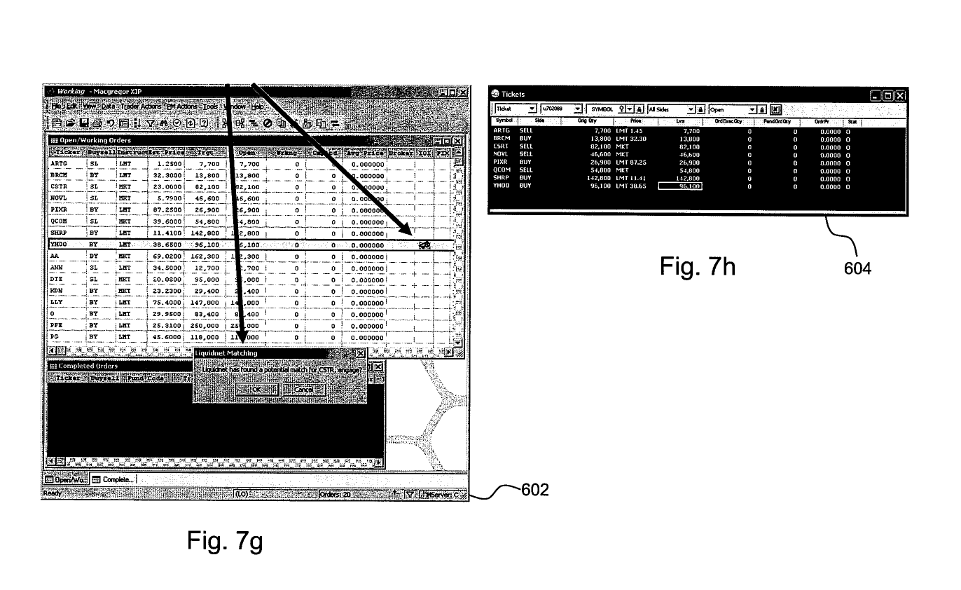

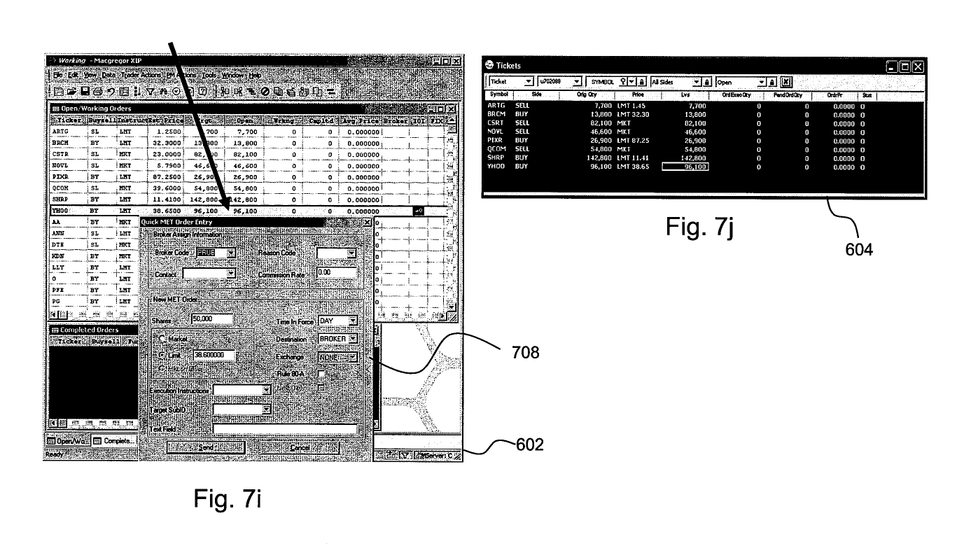

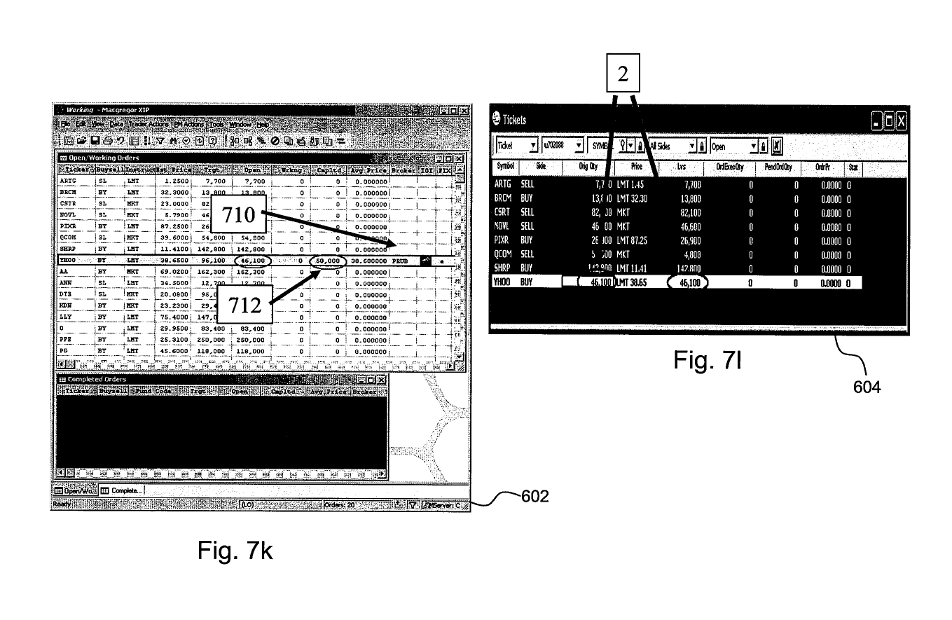

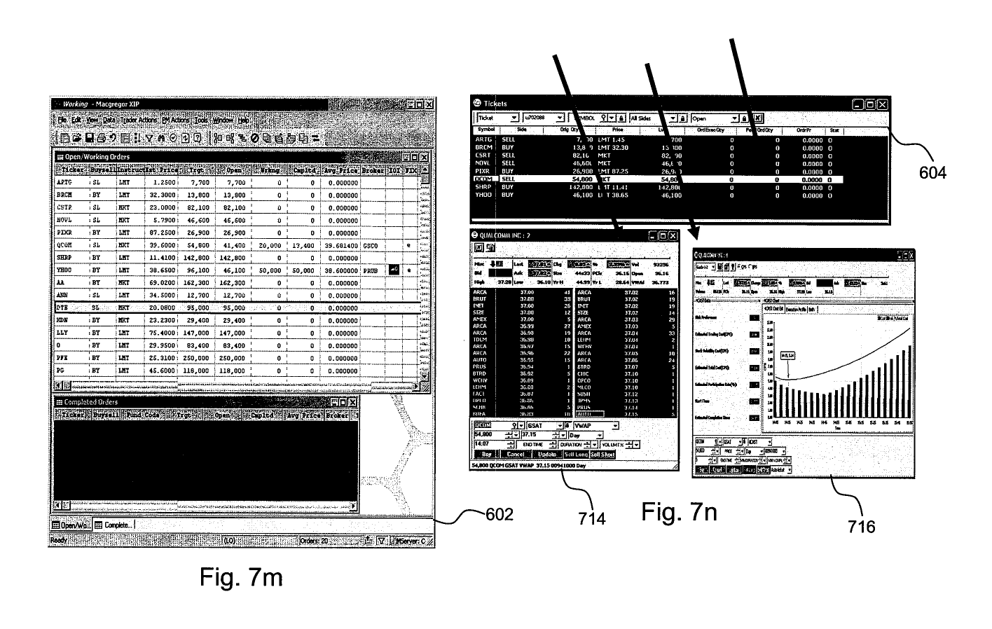

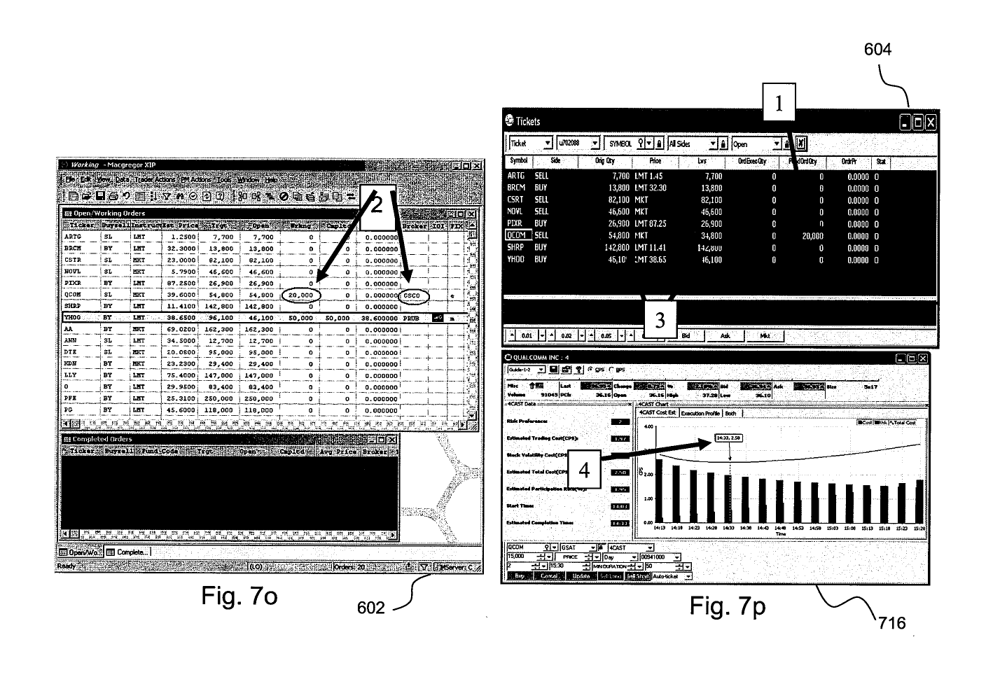

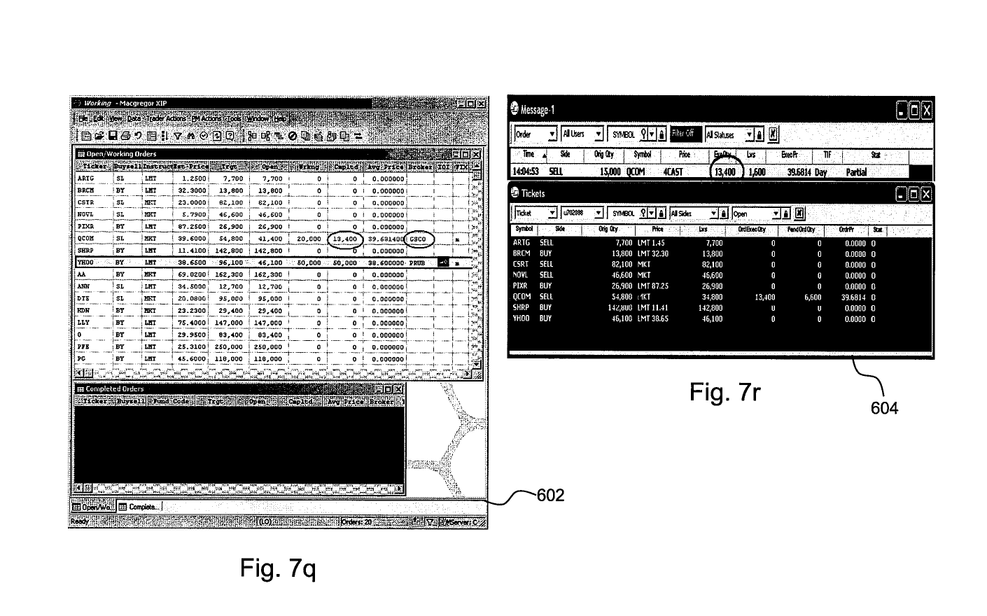

FIGS. 7a-7r are screen shots of an OMS trade blotter and EP system that are integrated together according to an embodiment of the present invention. Together, FIGS. 7a-7r illustrate exemplary data flow between the OMS and EP systems according to systems and methods already described above.

FIG. 7a illustrates the OMS ticker blotter 602 that is already described. FIG. 7b illustrates the EP ticket blotter window 604 as well as additional function windows 714 and 716 that are provided, and which can display real-time market and analysis information provided from the OMS, according to an integration of the present invention.

As shown in FIG. 7c, means are provided for sending orders to an EP system in the form of a drop down box in the OMS interface 602. Upon selection of the function, selected orders are inserted into the EP ticket window 604. Popups may be provided that allow selection of individual orders as described with reference to FIGS. 6a-6w above.

As shown in FIG. 7e, even though the orders are inserted into the EP ticket blotter window 604 (FIG. 7f), the working column 704 and the broker column 706 remain unchanged. That is, the orders themselves are not committed to the brokers, as is required with when shares are transferred from the OMS to the EP via FIX. Thus, these orders are fully available to the user of the OMS system.

For example, as illustrated in FIG. 7g, if an IOI has arrived for a security, such as YHOO, the OMS user is free to work the shares of YHOO at his disposal. As illustrated in FIG. 7i, facilities for performing trading 708 can be provided within the ordering system for sending orders directly to a broker from the OMS. In this example, the limit order for YHOO can be sent to broker PRUB for a set price (38.6) and a set quantity (50,000).

As illustrated in FIGS. 7k and 7l, upon submission of the orders for YHOO to PRUB, the amount of shares available in the EP ticket window 604 is decremented to 46,100 shares. Likewise, the 50,000 shares of YHOO have been committed to PRUB in the OMS and, in this case, have already been executed as illustrated in column 712.

FIG. 7n illustrates additional features that are available in the EP system as a result of the novel integration of the present invention. As illustrated, when the user selects a ticker symbol in the EP blotter, associated real-time market data (e.g., level 2 data) can be provided within the window 714. Further, real-time or historical analytical data can be provided in an additional window 716. This market and analysis information is provided by the OMS system via the integration, as described above.

FIGS. 7o and 7p illustrate real-time events that trigger the flow of information between the OMS 602 and the EP 604. As shown, the user may choose to place shares from the EP ticker 604 for QCOM for the quantity of 20,000. Instantly, the working field 712 in the OMS is updated to reflect the amount of shares being worked by the Goldman Sachs EP system, and the broker column 714 in the OMS is updated to reflect that these shares are placed with the broker Goldman Sachs. Likewise, real-time data is updated in window 716 based on the trade that has been issued through the EP system. This information is updated from the OMS via the integration, as described above.

Accordingly, it should be understood that the present invention has the advantage that liquidity in an OMS is not committed to a broker when order information is exported from the OMS to the EP, as in the prior art systems. Further, because of the real-time integration between the OMS and the EP that allows for real-time updates and compliance checks to order information in both the OMS and EP simultaneously, a user is able to work the same shares from either the OMS or the EP as if they were available in both systems.

As illustrated in FIGS. 7q and 7r, as shares are executed by the EP system 604, the data is instantly updated to reflect the execution information.

Additionally, orders may be updated through combination or un-combination with other orders. These are special situations that must be handled by the trader's OMS. For example, if an order for 100,000 shares has been sent to the EP and a trader subsequently combines that order with another order for 50,000 shares, the new order sent to the EP will be for 150,000 shares. However, if the OMS fails to recognize the combination of the orders; the original order for 100,000 shares may remain outstanding, and thus expose the trader to a potential for over-execution. A similar situation is encountered when traders un-combine or split orders.

One or more aspects of the present invention may includes a computer-based product, which may be hosted on a storage medium and include executable for performing one or more steps of the invention. Such storage mediums can include, but are not limited to, computer disks including floppy or optical disks or diskettes, CDROMs, magneto-optical disk, ROMs, RAMs, EPROMs, EEPROMs, flash memory, magnetic or optical cards, or any type of media suitable for storing electronic instructions, either locally or remotely.

Thus, a number of preferred embodiments have been fully described above with reference to the drawing figures. Although the invention has been described based upon these preferred embodiments, it would be apparent to those of skill in the art that certain modifications, variations, and alternative constructions could be made to the described embodiments within the spirit and scope of the invention.

1. A method for integrating an order management system with execution facilities, said method comprising the following steps:
selecting at least one trade in an order management system (OMS) to be made available to be worked in an execution platform (EP);
sending order information corresponding to the selected at least one trade from the OMS to the EP without committing shares underlying the at least one trade in the OMS;
determining if the EP is attempting to generate, or has generated, an executable order corresponding to said selected at least one trade in the OMS; and
if said EP is determined to have generated or attempted to generate an executable order corresponding to said at least one trade in the OMS, creating a placement corresponding to said executable order in the OMS.

2. The method of claim 1, wherein the step of sending order information corresponding to the at least one trade to the EP further comprises:
sending the order information to an execution platform integration program (EPIP) from the OMS; and
sending the order information from the EPIP to the EP.

3. The method of claim 1, further comprising the steps of:
confirming that the placement in the OMS corresponding to said executable order can be created without violating compliance rules before the placement is created, and wherein said placement is only created if it is confirmed that the placement corresponding to said order at the OMS can be created without violating compliance rules.

4. The method of claim 1, further comprising the step of:
upon execution of a trade for the executable order, updating order information in the OMS and in the EP based on the execution.

5. The method of claim 1, further comprising steps of:
determining in real-time if trade information in the OMS or the EP has changed;
if trade information at the EP has changed corresponding to any one of the selected at least one trade, updating trade information in the OMS corresponding to the change at the EP; and
if trade information corresponding to any one of the selected at least one trade in the OMS has changed, sending a message to the EP to update trade information corresponding to the change at the OMS.

6. The method of claim 1, wherein the executable order is allowed to be generated by the EP prior to creating the corresponding placement in the OMS.

7. The method of claim 1, wherein the executable order is prevented from being generated by the EP until the corresponding placement is successfully created in the OMS.

8. The method of claim 1, wherein the EP is associated with a broker.

9. The method of claim 1, wherein information is transmitted between the OMS and EP by event triggered messages.

10. A computer-readable storage medium having computer executable program instructions stored therein for integrating an order management system with execution facilities, by performing the following operations:
selecting at least one trade in an order management system (OMS) to be made available to be worked in an execution platform (EP);
sending order information corresponding to the selected at least one trade from the OMS to the EP, without committing shares underlying the at least one trade;
determining if the EP is attempting to generate, or has generated, an executable trade order corresponding to said order information received from the OMS; and
if said EP is determined to have generated or attempted to generate an executable order corresponding to said at least one trade in the OMS, creating a placement corresponding to said executable order in the OMS.

11. The computer-readable storage medium of claim 10, wherein the operation of sending order information corresponding to the at least one trade to the EP further comprises:
sending the order information to an execution platform integration program (EPIP) from the OMS; and
sending the order information from the EPIP to the EP.

12. The computer-readable storage medium of claim 10, further comprising operations for:
confirming that the placement at the OMS corresponding to said executable order can be created without violating compliance rules, and wherein said placement is only created if it is confirmed that the placement corresponding to said order at the OMS can be created without violating compliance rules.

13. The computer-readable storage medium of claim 10, further comprising the operation of:
upon execution of the order, updating order information in the OMS and the EP based on the execution.

14. The computer-readable storage medium of claim 10, further comprising operations of:
determining in real-time if the trade information in the OMS or the EP has changed;
if trade information at the EP has changed, updating trade information in the OMS corresponding to the change at the EP; and
if trade information in the OMS has changed, sending a message to the EP to update trade information corresponding to the change at the OMS.

15. The computer-readable storage medium of claim 10, wherein the executable order is allowed to be generated by the EP prior to creating the corresponding placement in the OMS.

16. The computer-readable storage medium of claim 10, wherein the executable order is prevented from being generated by the EP until the corresponding placement is successfully created in the OMS.

17. The computer-readable storage medium of claim 10, wherein the EP is associated with a broker.

18. The computer-readable storage medium of claim 10, wherein information is transmitted between the OMS and EP by event triggered messages.

19. A system for integrating an order management system with execution facilities, said system comprising:
means for selecting at least one trade in an order management system (OMS) to be available to be worked in an execution platform (EP);
means for sending order information corresponding to the at least one trade from the OMS to the EP without committing shares underlying the at least one trade in the OMS;
means for determining if the EP is attempting to generate or has generated an executable order corresponding to said order information received from the OMS; and
means for creating a placement corresponding to said executable order at the OMS if said EP is determined to have generated or attempted to generate an executable order corresponding to said at least one trade in the OMS.

20. The system of claim 19, wherein the means for sending order information corresponding to the at least one trade to the EP further sends the order information to an execution platform integration program (EPIP) from the OMS and sends the order information from the EPIP to the EP.

21. The system of claim 19, further comprising:
means for confirming that the placement at the OMS corresponding to said executable order can be created without violating compliance rules, and wherein said placement is only created if it is confirmed that the placement corresponding to said order at the OMS can be created without violating compliance rules.

22. The system of claim 19, wherein upon execution of the order, order information is updated in the OMS and the EP based on the execution.

23. The system of claim 19, further comprising:
means for determining in real-time if the trade information in the OMS or the EP has changed;
means for updating trade information in the OMS corresponding to the change at the EP if trade information at the EP has changed; and
means for sending a message to the EP to update trade information corresponding to the change at the OMS if trade information in the OMS has changed.

24. The system of claim 19, wherein the executable order is allowed to be generated by the EP prior to creating the corresponding placement in the OMS.

25. The system of claim 19, wherein the executable order is prevented from being generated by the EP until the corresponding placement is successfully created in the OMS.

26. The system of claim 19, wherein the EP is associated with a broker.

27. The system of claim 19, wherein information is transmitted between the OMS and EP by event triggered messages.

28. A trade integration system for an order management system (OMS), the OMS comprising OMS data storage facilities for storing trade data, an OMS user interface coupled with the OMS data storage facilities and configured to create and maintain said trade data, and order generation facilities coupled with at least the data storage facilities and configured to generate, in response to an instruction of the OMS user interface, one or more orders to trade securities and transmit said orders to a user selected destination, and to update the trade data to reflect the generated and transmitted orders, said trade integration system comprising:
execution platform integration facilities coupled with at least said data storage facilities and an execution platform (EP), and configured to synchronize data in said EP and said data storage facilities but without committing shares in the OMS to the EP until an executable trade order is generated by said EP.

29. The system of claim 28, wherein said execution platform integration facilities are further configured to confirm that the placement at the OMS corresponding to said executable order can be created without violating compliance rules, and wherein said placement is only created if it is confirmed that the placement corresponding to said order at the OMS can be created without violating compliance rules.

30. The system of claim 28, wherein said execution platform integration facilities are further configured to update order information in the OMS and the EP based on the execution upon execution of the executable order.

31. The system of claim 28, wherein said execution platform integration facilities are further configured to determine in real-time if the trade information in the OMS or the EP has changed, and if trade information at the EP has changed, to update trade information in the OMS corresponding to the change at the EP, and if trade information in the OMS has changed, to send a message to the EP to update trade information corresponding to the change at the OMS.

32. The system of claim 28, wherein the executable order is allowed to be generated by the EP prior to creating the corresponding placement in the OMS.

33. The system of claim 28, wherein the executable order is prevented from being generated by the EP until the corresponding placement is successfully created in the OMS.

34. The system of claim 28, wherein the EP is associated with a broker.

35. The system of claim 28, wherein said execution platform integration facilities communicate with said OMS and said EP using event triggers messaging.
